(19) United States
(12) Patent Application Publication
(10) Pub. No.: US 2010/0088022 A1
(43) Pub. Date: Apr. 8, 2010

(54) SYSTEM AND METHOD FOR GENERATING A ROUTE-OPTIMIZED BUSINESS LOCATOR

(76) Inventors: Silvy WILSON, Rancho Santa Margarita, CA (US); Fabio Gava, Ladera Ranch, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/246,875

(22) Filed: Oct. 7, 2008

(51) Int. Cl. G06F 19/00; G06F 17/30; G06F 7/10

(52) U.S. Cl. 701/202; 707/E17.014

(57) ABSTRACT

The subject application is directed to a route-optimized commercial business locator system and method. Location data is first received corresponding to a location of each of a plurality of alternative business locations. Routing data is then received corresponding to a desired travel route of an associated user. Location data of each of the alternative business locations is then compared to the routing data. Distance data is then generated corresponding to the distance of each of the locations from the desired travel route based upon the output of the comparison. A display is then generated corresponding to each of the business locations and their associated distance data.

### BACKGROUND OF THE INVENTION

The subject application is directed generally to a system and method for assisting consumers in locating business establishments. The application is particularly applicable to assisting consumers in locating a business establishment that is optimally located relative to a planned route of travel.

Search engines are a popular method for locating business establishments that are available for a needed product or service, such as retail products, restaurants, service establishments, or document processing establishments. A user may enter a query on a general search engine, such as Yahoo or Google, and view a list of establishments that satisfy a particular need. In addition to general search engines, some businesses having multiple locations will also provide users with the ability to search for alternate locations which may be more conveniently located.

Often times, business inquires are made in connection with supplied location information, such as an address or ZIP code where a consumer is located. A search engine will provide a listing of various alternative business sites proximate to the supplied location information. On occasion, this listing will include an approximate distance to the establishment from the supplied location information.

While the above-described systems are extremely useful, they may result in listing of alternative locations that, while relatively proximate to a supplied location, are out-of-the-way relative to a planned destination unrelated to the alternative business location listings

### SUMMARY OF THE INVENTION

In accordance with one embodiment of the subject application, there is provided a system and method for assisting consumers in locating business establishments.

Further, in accordance with one embodiment of the subject application, there is provided a system and method for assisting consumers in locating a business establishment that is optimally located relative to a planned route of travel.

Still further in accordance with one embodiment of the subject application, there is provided a route-optimized commercial business locator system and method. Location data corresponding to a location of each of a plurality of alternative business locations is received, as well as routing data corresponding to a desired travel route of an associated user. Location data of each of the plurality of alternative business locations is compared to the received routing data. Distance data corresponding to a distance of each of the plurality of alternative business locations from the desired travel route is generated in accordance with an output of the comparison, and a display is generated corresponding to each of the alternative business locations and distance data associated therewith.

Still other advantages, aspects, and features of the subject application will become readily apparent to those skilled in the art from the following description, wherein there is shown and described a preferred embodiment of the subject application, simply by way of illustration of one of the modes best suited to carry out the subject application. As it will be realized, the subject application is capable of other different embodiments, and its several details are capable of modifications in various obvious aspects, all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a route-optimized commercial business locator system according to one embodiment of the subject application;

FIG. 2 is a block diagram illustrating device hardware for use in the route-optimized commercial business locator system according to one embodiment of the subject application;

FIG. 3 is a functional diagram illustrating the device for use in the route-optimized commercial business locator system according to one embodiment of the subject application;

FIG. 4 is a block diagram illustrating controller hardware for use in the route-optimized commercial business locator system according to one embodiment of the subject application;

FIG. 5 is a functional diagram illustrating the controller for use in the route-optimized commercial business locator system according to one embodiment of the subject application;

FIG. 6 is a block diagram illustrating server hardware for use in the route-optimized commercial business locator system according to one embodiment of the subject application;

FIG. 7 is a block diagram illustrating the route-optimized commercial business locator system according to one embodiment of the subject application;

FIG. 8 is a functional diagram illustrating the route-optimized commercial business locator system according to one embodiment of the subject application;

FIG. 9 is a flowchart illustrating a route-optimized commercial business locator method according to one embodiment of the subject application; and

FIG. 10 is a flowchart illustrating a route-optimized commercial business locator method according to one embodiment of the subject application.

### DETAILED DESCRIPTION OF THE PREFERRED EMBODIMENT

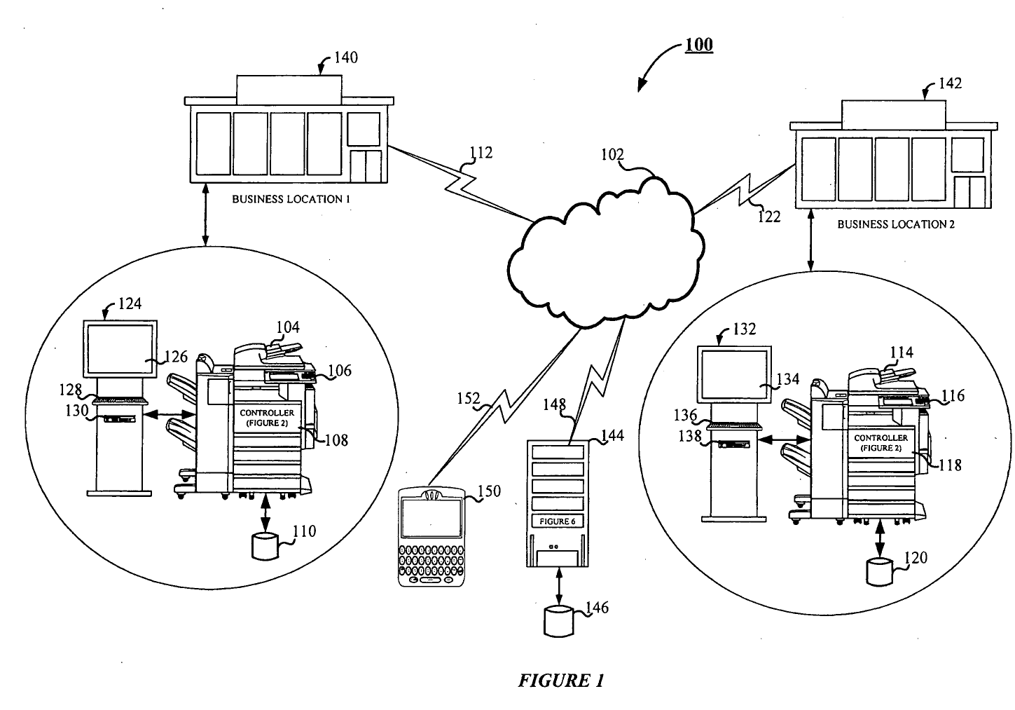

The subject application is directed to a system and method for assisting consumers in locating business establishments. In particular, the subject application is directed to a system and method for assisting consumers in locating a business establishment that is optimally located relative to a planned route of travel. It will become apparent to those skilled in the art that the system and method described herein are suitably adapted to a plurality of varying electronic fields employing location-based assistance including, for example and without limitation, communications, general computing, data processing, document processing, financial transactions, vending of products or services, and the like. The preferred embodiment, as depicted in FIG. 1, illustrates a document processing field for example purposes only and is not a limitation of the subject application solely to such a field.

Referring now to FIG. 1, there is shown an overall diagram of a route-optimized commercial business locator system 100 in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art that is capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad conventional data transport mechanisms such as, for example and without limitation, Token-Ring, 802.11(x), Ethernet, or other wireless or wire-based data communication mechanisms. The skilled artisan will appreciate that, while a computer network 102 is shown in FIG. 1, the subject application is equally capable of use in a stand-alone system, as will be known in the art.

The example system 100 illustrated in FIG. 1 also includes a first document processing device 104 associated with a first business location 140 and a second document processing device 114 associated with a second business location 142; such devices 104 and 114 are depicted in FIG. 1 as multifunction peripheral devices suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially-available document processing devices include, for example and without limitation, the Toshiba e-Studio Series Controller. In accordance with one aspect of the subject application, the document processing devices 104 and 114 are suitably adapted to provide remote document processing services to external or network devices. Preferably, the document processing devices 104 and 114 include hardware, software, or any suitable combination thereof configured to interact with an associated user, a networked device, or the like. It will be understood by those skilled in the art that the system 100 is capable of including any number of business locations in addition to the first and second locations 140 and 142, each of which is capable of hosting a plurality of document processing devices associated therewith. Thus, the skilled artisan will appreciate that the single devices 104 and 114 associated with such first and second locations 140 and 142 are shown for example purposes only and are not intended to limit each location 140 and 142 to a single associated device.

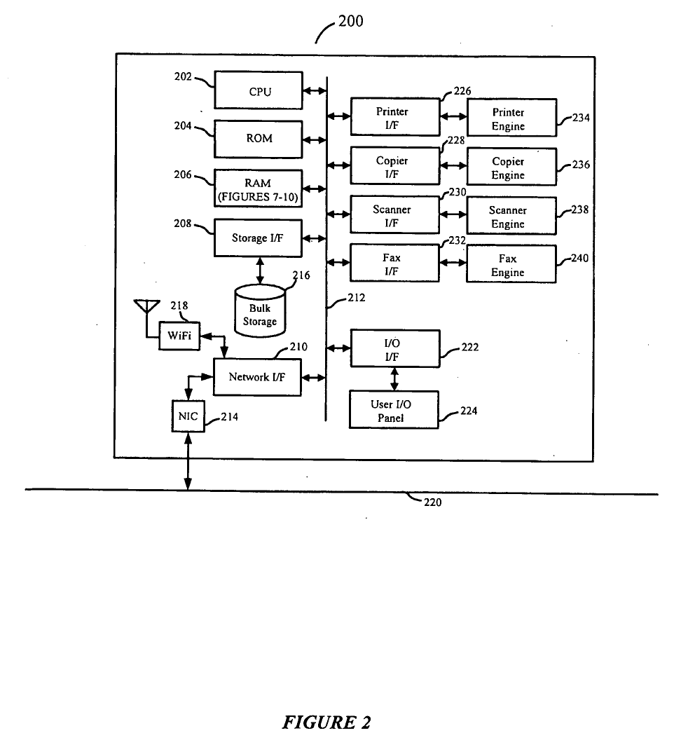

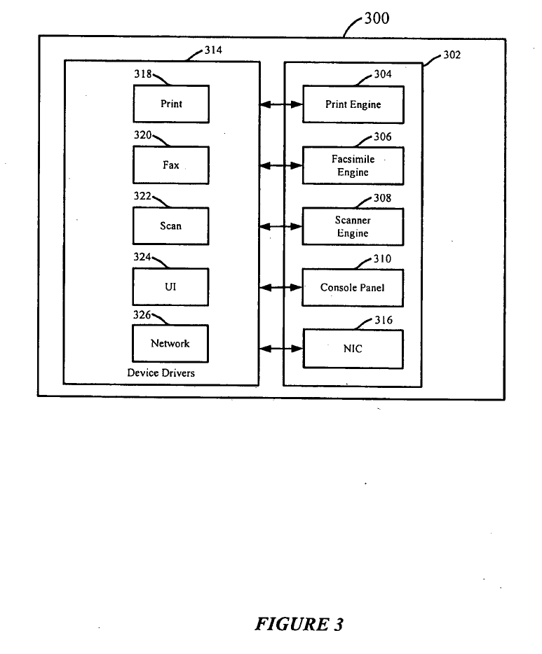

According to one embodiment of the subject application, the document processing devices 104 and 114 are suitably equipped to receive a plurality of portable storage media including, without limitation, Firewire drive, USB drive, SD, MMC, XD, compact flash, memory stick, and the like. In the preferred embodiment of the subject application, the document processing devices 104 and 114 further include associated user interfaces 106 and 116, respectively, such as a touchscreen, LCD display, touch-panel, alpha-numeric keypad, or the like, via which an associated user is able to interact directly with the corresponding document processing device 104 or 114. In accordance with the preferred embodiment of the subject application, the user interfaces 106 and 116 are advantageously used to communicate information to the associated user and to receive selections from the associated user. The skilled artisan will appreciate that the user interfaces 106 and 116 comprise various components suitably adapted to present data to the associated user, as are known in the art. In accordance with one embodiment of the subject application, the user interfaces 106 and 116 comprise a display suitably adapted to display one or more graphical elements, text data, images, or the like to an associated user; to receive input from the associated user; and to communicate the same to a backend component, such as the controllers 108 and 118, as explained in greater detail below. Preferably, the document processing devices 104 and 114 are communicatively coupled to the computer network 102 via communications links 112 and 122. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art. The functioning of the document processing devices 104 and 114 will be better understood in conjunction with the block diagrams illustrated in FIGS. 2 and 3, explained in greater detail below.

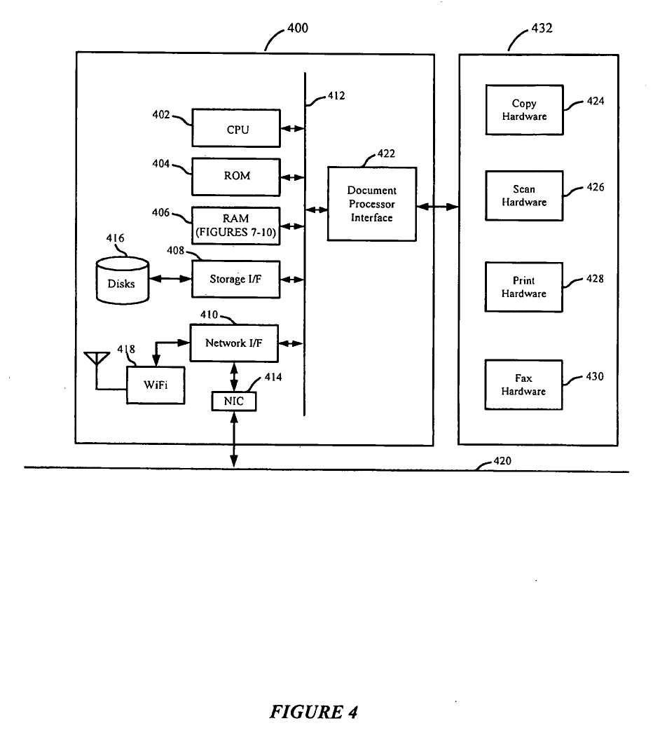

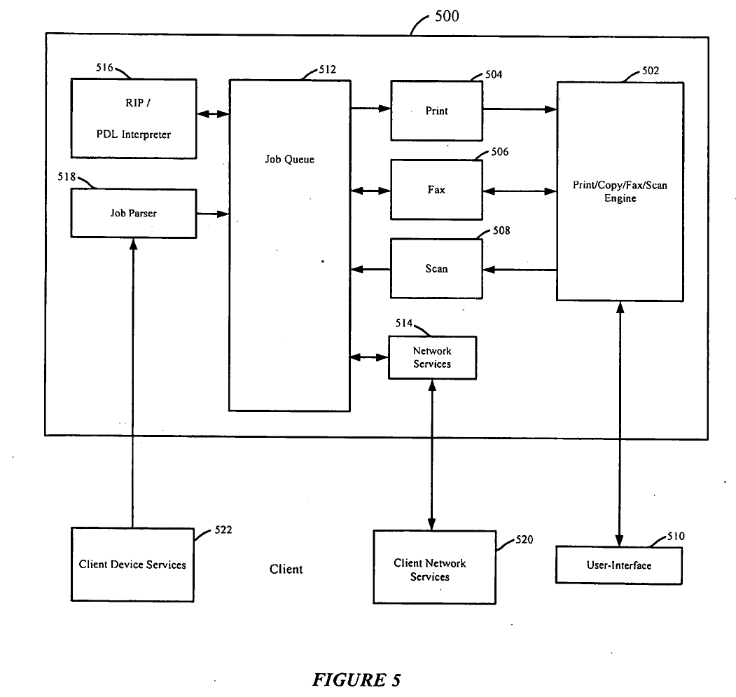

In accordance with one embodiment of the subject application, the document processing devices 104 and 114 incorporate backend components, designated as the controllers 108 and 118, suitably adapted to facilitate the operations of the document processing devices 104 and 114, as will be understood by those skilled in the art. Preferably, the controllers 108 and 118 are embodied as hardware, software, or any suitable combination thereof configured to control the operations of the associated document processing device 104 or 114, to facilitate the display of images via the user interfaces 106 and 116, to direct the manipulation of electronic image data, and the like. For purposes of explanation, the controllers 108 and 118 are used to refer to any of the myriad components associated with the document processing devices 104 and 114, including hardware, software, or combinations thereof functioning to perform, cause to be performed, control, or otherwise direct the methodologies described hereinafter. It will be understood by those skilled in the art that the methodologies described with respect to the controllers 108 and 118 are capable of being performed by any general purpose computing system known in the art, and thus the controllers 108 and 118 are representative of such general computing devices and are intended as such when used hereinafter. Furthermore, the use of the controllers 108 and 118 hereinafter is for the example embodiment only, and other embodiments that will be apparent to one skilled in the art are capable of employing the route-optimized commercial business locator system and method. The functioning of the controllers 108 and 118 will be better understood in conjunction with the block diagrams illustrated in FIGS. 4 and 5, explained in greater detail below.

Communicatively coupled to the document processing devices 104 and 114 are data storage devices 110 and 120, respectively. In accordance with the one embodiment of the subject application, the data storage devices 110 and 120 are any mass storage device known in the art including, for example and without limitation, magnetic storage drives, hard disk drives, optical storage devices, flash memory devices, or any suitable combination thereof. In one embodiment, the data storage devices 110 and 120 are suitably adapted to store scanned image data, modified image data, redacted data, user information, cellular telephone data, pre-set payment data, document data, image data, electronic database data, or the like. It will be appreciated by those skilled in the art that, while illustrated in FIG. 1 as being a separate component of the system 100, the data storage devices 110 and 120 are capable of being implemented as an internal storage component of the document processing devices 104 and 114, a component of the controllers 108 and 118, or the like such as, for example and without limitation, an internal hard disk drive or the like. In accordance with one embodiment of the subject application, the data storage devices 110 and 120 are capable of storing document processing instructions, usage data, user interface data, job control data, controller status data, component execution data, images, advertisements, user information, location information, output templates, mapping data, multimedia data files, fonts, and the like.

FIG. 1 also illustrates kiosks 124 and 132 communicatively coupled to the document processing devices 104 and 114 and, in effect, to the computer network 102. It will be appreciated by those skilled in the art that the kiosks 124 and 132 are capable of being implemented as separate components of the document processing devices 104 and 114 or as integral components thereof. Use of the kiosks 124 and 132 in FIG. 1 is for example purposes only, and the skilled artisan will appreciate that the subject application is capable of implementation without the use of the kiosks 124 and 132. In accordance with one embodiment of the subject application, the kiosks 124 and 132 include associated displays 126 and 134 and user input devices 128 and 136, respectively. As will be understood by those skilled in the art, the kiosks 124 and 132 are capable of implementing a combination user input device/display, such as a touchscreen interface. According to one embodiment of the subject application, the kiosks 124 and 132 are suitably adapted to display prompts to an associated user, to receive document processing instructions from the associated user, to receive payment data, to receive selection data from the associated user, and the like. Preferably, the kiosks 124 and 132 include magnetic card readers, conventional bar code readers, or the like suitably adapted to receive and read payment data from credit cards, coupons, debit cards, or the like.

The system 100 of FIG. 1 also includes portable storage device readers 130 and 138, respectively coupled to the kiosks 124 and 132, which are suitably adapted to receive and access myriad different portable storage devices. Examples of such portable storage devices include, for example and without limitation, flash-based memory such as SD, xD, memory stick, compact flash, CD-ROM, DVD-ROM, USB flash drives, or other magnetic or optical storage devices, as will be known in the art.

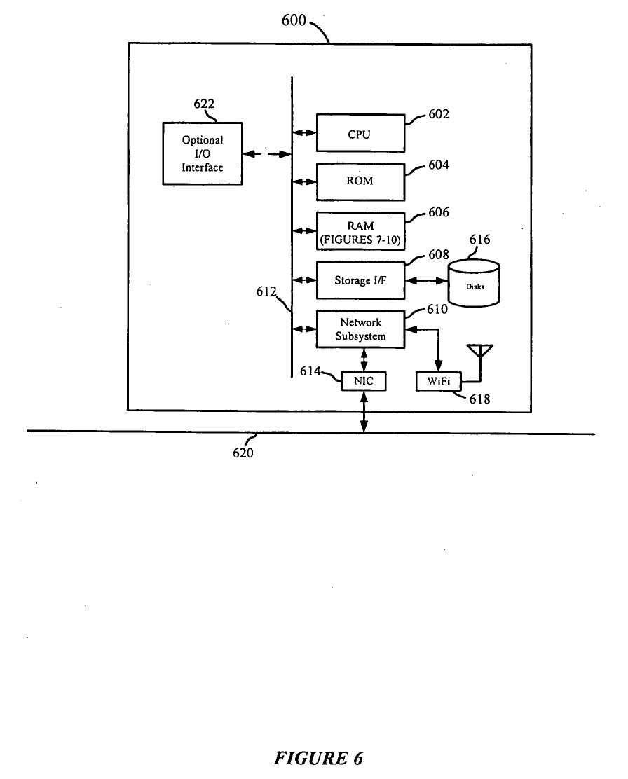

The system 100 illustrated in FIG. 1 further depicts a backend component, shown as the server 144, in data communication with the computer network 102 via a communications link 148. It will be appreciated by those skilled in the art that the server 144 is shown in FIG. 1 as a component of the system 100 for example purposes only, and the subject application is capable of implementation without the use of a separate backend server component. The skilled artisan will appreciate that the server 144 comprises hardware, software, and combinations thereof suitably adapted to provide one or more services, web-based applications, storage options, and the like to networked devices. In accordance with one example embodiment of the subject application, the server 144 includes various components, implemented as hardware, software, or a combination thereof for managing retention of secured documents and text data, performing searches and comparisons, providing routing operations, storing business location data, maintaining data records and account information, receiving payment data, retrieving documents, and the like, which are accessed via the computer network 102. The communications link 148 is any suitable data communications means known in the art including but not limited to wireless communications comprising, for example and without limitation, Bluetooth, WiMax, 802.11a, 802.11b, 802.11g, 802.11(x), a proprietary communications network, infrared, the public switched telephone network, optical, or any suitable wireless data transmission system or wired communications known in the art. It will further be appreciated by those skilled in the art that the components described with respect to the server 144 are capable of implementation on any suitable computing device coupled to the computer network 102, e.g. the controllers 108 and 118 or the like. The functioning of the server 144 will better be understood in conjunction with the diagram illustrated in FIG. 6, explained in greater detail below.

Communicatively coupled to the server 144 is the data storage device 146. According to the foregoing example embodiment, the data storage device 146 is any mass storage device, or plurality of such devices, known in the art including, for example and without limitation, magnetic storage drives, hard disk drives, optical storage devices, flash memory devices, or any suitable combination thereof. In such an embodiment, the data storage device 146 is suitably adapted to store software updates, secured electronic documents, text data, data strings, account information, policy information, and the like. It will be appreciated by those skilled in the art that, while illustrated in FIG. 1 as being a separate component of the system 100, the data storage device 146 is capable of being implemented as an internal storage component of the server 144 or the like such as, for example and without limitation, an internal hard disk drive or the like.

The system 100 illustrated in FIG. 1 further depicts a mobile user device 150 in data communication with the computer network 102 via a communications link 152. It will be appreciated by those skilled in the art that the mobile user device 150 is shown in FIG. 1 as a portable communications device for illustration purposes only. As will be understood by those skilled in the art, the mobile user device 150 is representative of any mobile personal communications device known in the art including, for example and without limitation, a personal data assistant, a web-enabled cellular telephone, a smart phone, a proprietary network device, or other web-enabled communications device. The communications link 152 is any suitable channel of data communications known in the art including but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system or wired communications known in the art. Preferably, the mobile user device 150 is suitably adapted to send and receive text messages, to browse the Internet, to communicate user information and password data, to receive status or job data, or the like with respect to the document processing devices 104 and 114 or any other similar device coupled to the computer network 102.

Turning now to FIG. 2, illustrated is a representative architecture of a suitable device 200, shown in FIG. 1 as the document processing device 104, on which operations of the subject system are completed. Included is a processor 202 suitably comprised of a central processor unit. However, it will be appreciated that the processor 202 may be advantageously composed of multiple processors working in concert with one another, as will be appreciated by one of ordinary skill in the art. Also included is a non-volatile or read only memory 204, which is advantageously used for static or fixed data or instructions such as BIOS functions, system functions, system configuration data, and other routines or data used for operation of the device 200.

Also included in the device 200 is random access memory 206 suitably formed of dynamic random access memory, static random access memory, or any other suitable addressable memory system. Random access memory 206 provides a storage area for data instructions associated with applications and data handling accomplished by the processor 202.

A storage interface 208 suitably provides a mechanism for volatile, bulk, or long-term storage of data associated with the device 200. The storage interface 208 suitably uses bulk storage, such as any suitable addressable or serial storage such as a disk, optical, tape drive, and the like as shown as 216, as well as any suitable storage medium, as will be appreciated by one of ordinary skill in the art.

A network interface subsystem 210 suitably routes input and output from an associated network, allowing the device 200 to communicate to other devices. The network interface subsystem 210 suitably interfaces with one or more connections with external devices to the device 200. By way of example, illustrated is at least one network interface card 214 for data communication with fixed or wired networks such as Ethernet, Token-Ring, and the like and a wireless interface 218 suitably adapted for wireless communication via means such as WiFi, WiMax, wireless modem, cellular network, or any suitable wireless communication system. It is to be appreciated, however, that the network interface subsystem 210 suitably utilizes any physical or non-physical data transfer layer or protocol layer, as will be appreciated by one of ordinary skill in the art. In the illustration, the network interface card 214 is interconnected for data interchange via a physical network 220 suitably comprised of a local area network, wide area network, or a combination thereof.

Data communication between the processor 202, read only memory 204, random access memory 206, storage interface 208, and the network subsystem 210 is suitably accomplished via a bus data transfer mechanism, such as illustrated by the bus 212.

Suitable executable instructions on the device 200 facilitate communication with a plurality of external devices such as workstations, document processing devices, other servers, or the like. While, in operation, a typical device operates autonomously, it is to be appreciated that direct control by a local user is sometimes desirable and is suitably accomplished via an optional input/output interface 222 to a user input/output panel 224, as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device, depicted in FIG. 1 as the document processing device 104, for use in connection with the disclosed system. FIG. 3 illustrates suitable functionality of the hardware of FIG. 2 in connection with software and operating system functionality, as will be appreciated by one of ordinary skill in the art. The document processing device 300 suitably includes an engine 302 that facilitates one or more document processing operations.

The document processing engine 302 suitably includes a print engine 304, facsimile engine 306, scanner engine 308, and console panel 310. The print engine 304 allows for output of physical documents representative of an electronic document communicated to the processing device 300. The facsimile engine 306 suitably communicates to or from external facsimile devices via a device such as a fax modem.

The scanner engine 308 suitably functions to receive hard copy documents and, in turn, image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format and is also suitably configured for optical character recognition. Tangible document scanning also suitably functions to facilitate facsimile output thereof.

In the illustration of FIG. 3, the document processing engine also comprises an interface 316 with a network via driver 326 suitably comprised of a network interface card. It will be appreciated that a network thoroughly accomplishes that interchange via any suitable physical and non-physical layer such as wired, wireless, or optical data communication.

The document processing engine 302 is suitably in data communication with one or more device drivers 314, which device drivers 314 allow for data interchange from the document processing engine 302 to one or more physical devices to accomplish the actual document processing operations. Such document processing operations include one or more of printing via driver 318, facsimile communication via driver 320, scanning via driver 322, and a user interface functions via driver 324. It will be appreciated that these various devices are integrated with one or more corresponding engines associated with the document processing engine 302. It is to be appreciated that any set or subset of document processing operations are contemplated herein. Document processors that include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device known in the art that is capable of facilitating the methodologies described herein. Included is a processor 402 suitably comprised of a central processor unit. However, it will be appreciated that processor 402 may advantageously be composed of multiple processors working in concert with one another, as will be appreciated by one of ordinary skill in the art. Also included is a non-volatile or read only memory 404, which is advantageously used for static or fixed data or instructions such as BIOS functions, system functions, system configuration data, and other routines or data used for operation of the controller 400.

Also included in the controller 400 is random access memory 406 suitably formed of dynamic random access memory, static random access memory, or any other suitable addressable and writable memory system. Random access memory 406 provides a storage area for data instructions associated with applications and data handling accomplished by processor 402.

A storage interface 408 suitably provides a mechanism for non-volatile, bulk, or long-term storage of data associated with the controller 400. The storage interface 408 suitably uses bulk storage, such as any suitable addressable or serial storage such as a disk, optical, tape drive, and the like as shown as 416, as well as any suitable storage medium, as will be appreciated by one of ordinary skill in the art.

A network interface subsystem 410 suitably routes input and output from an associated network, allowing the controller 400 to communicate to other devices. The network interface subsystem 410 suitably interfaces with one or more connections with external devices to the device 400. By way of example, illustrated is at least one network interface card 414 for data communication with fixed or wired networks such as Ethernet, Token-Ring, and the like and a wireless interface 418 suitably adapted for wireless communication via means such as WiFi, WiMax, wireless modem, cellular network, or any suitable wireless communication system. It is to be appreciated, however, that the network interface subsystem 410 suitably utilizes any physical or non-physical data transfer layer or protocol layer, as will be appreciated by one of ordinary skill in the art. In the illustration, the network interface 414 is interconnected for data interchange via a physical network 420 suitably comprised of a local area network, wide area network, or a combination thereof.

Data communication between the processor 402, read only memory 404, random access memory 406, storage interface 408, and the network interface subsystem 410 is suitably accomplished via a bus data transfer mechanism, such as illustrated by bus 412.

Also in data communication with the bus 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4 (shown in FIG. 1 as the controller 108) as an intelligent subsystem associated with a document processing device. In the illustration of FIG. 5, controller function 500 in the preferred embodiment includes a document processing engine 502. Suitable controller functionality is that incorporated into the Toshiba e-Studio system in the preferred embodiment. FIG. 5 illustrates suitable functionality of the hardware of FIG. 4 in connection with software and operating system functionality, as will be appreciated by one of ordinary skill in the art.

In the preferred embodiment, the engine 502 allows for printing operations, copy operations, facsimile operations, and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited-purpose document processing devices that perform one or more of the document processing operations listed above.

The engine 502 is suitably interfaced to a user interface panel 510, which panel 510 allows for a user or administrator to access functionality controlled by the engine 502. Access is suitably enabled via an interface local to the controller or remotely via a remote thin or thick client.

The engine 502 is in data communication with the print function 504, facsimile function 506, and scan function 508. These functions 504, 506, 508 facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 308 for subsequent handling via the job queue 512.

The job queue 512 is also in data communication with network services 514. In a preferred embodiment, job control, status data, or electronic document data is exchanged between the job queue 512 and network services 514. Thus, suitable interface is provided for network-based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supply data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506, or scan 508.

Finally, the job queue 512 is in data communication with a parser 518, which parser 518 suitably functions to receive print job language files from an external device, such as client device services 522. The client device services 522 suitably include printing, facsimile transmission, or other suitable input of an electronic document for which handling by the controller function 500 is advantageous. The parser 518 functions to interpret a received electronic document file and relay it to the job queue 512 for handling in connection with the afore-described functionality and components.

Turning now to FIG. 6, illustrated is a representative architecture of a suitable server 600, depicted in FIG. 1 as the server 144, on which operations of the subject system are completed. Included is a processor 602 suitably comprised of a central processor unit. However, it will be appreciated that processor 602 may advantageously be composed of multiple processors working in concert with one another, as will be appreciated by one of ordinary skill in the art. Also included is a non-volatile or read only memory 604 that is advantageously used for static or fixed data or instructions such as BIOS functions, system functions, system configuration, and other routines or data used for operation of the server 600.

Also included in the server 600 is random access memory 606 suitably formed of dynamic random access memory, static random access memory, or any other suitable addressable memory system. Random access memory 606 provides a storage area for data instructions associated with applications and data handling accomplished by the processor 602.

A storage interface 608 suitably provides a mechanism for volatile, bulk, or long-term storage of data associated with the server 600. The storage interface 608 suitably uses bulk storage, such as any suitable addressable or serial storage such as a disk, optical, tape drive, and the like as shown as 616, as well as any suitable storage medium, as will be appreciated by one of ordinary skill in the art.

A network interface subsystem 610 suitably routes input and output from an associated network, allowing the server 600 to communicate to other devices. The network interface subsystem 610 suitably interfaces with one or more connections with external devices to the server 600. By way of example, illustrated is at least one network interface card 614 for data communication with fixed or wired networks such as Ethernet, Token-Ring, and the like and a wireless interface 618 suitably adapted for wireless communication via means such as WiFi, WiMax, wireless modem, cellular network, or any suitable wireless communication system. It is to be appreciated, however, that the network interface subsystem 610 suitably utilizes any physical or non-physical data transfer layer or protocol layer, as will be appreciated by one of ordinary skill in the art. In the illustration, the network interface 614 is interconnected for data interchange via a physical network 620 suitably comprised of a local area network, wide area network, or a combination thereof.

Data communication between the processor 602, read only memory 604, random access memory 606, storage interface 608, and the network subsystem 610 is suitably accomplished via a bus data transfer mechanism, such as illustrated by bus 612.

Suitable executable instructions on the server 600 facilitate communication with a plurality of external devices such as workstations, document processing devices, other servers, or the like. While, in operation, a typical server operates autonomously, it is to be appreciated that direct control by a local user is sometimes desirable and is suitably accomplished via an optional input/output interface 622, as will be appreciated by one of ordinary skill in the art.

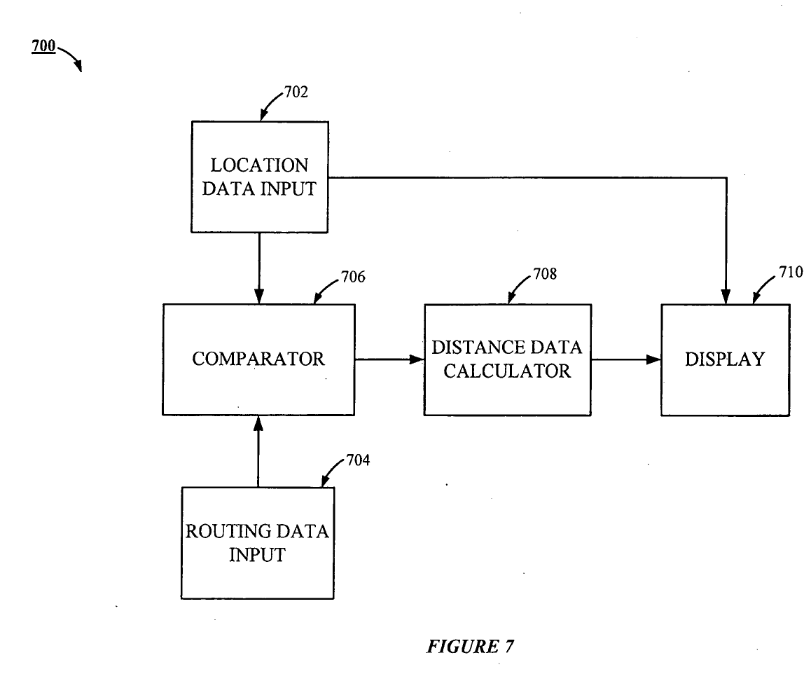

Turning now to FIG. 7, illustrated is a block diagram of a route-optimized commercial business locator system 700 in accordance with one embodiment of the subject application. The system 700 includes a location data input 702, which receives location data corresponding to the locations of a plurality of alternative business locations. The system 700 further includes a routing data input 704 configured to receive routing data corresponding to a desired travel route of an associated user. A comparator 706 then receives the location data from the location data input 702 and the routing data from the routing data input 704. The system 100 also incorporates a distance data calculator 708 that is operable on data corresponding to the distance of each of the alternative business locations from the desired travel route in accordance with the output from the comparator 706. In addition, the system includes a display 710, which is configured to depict each of the business locations and the associated distance data for viewing by an associated user.

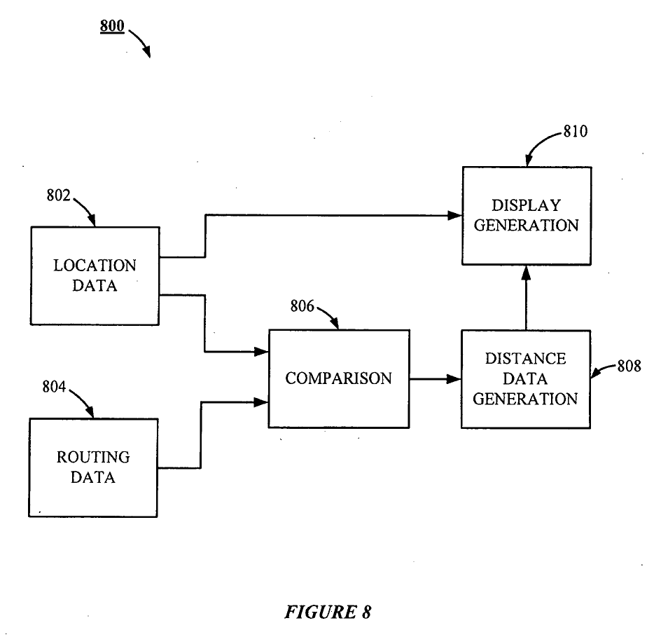

Referring now to FIG. 8, there is shown a functional diagram 800 illustrating the route-optimized commercial business locator system in accordance with one embodiment of the subject application. Location data 802 is first received corresponding to the location of each of a plurality of alternative business locations, e.g. the first business location 140 and the second business location 142. Routing data 804 is then received corresponding to a desired travel route of an associated user, e.g. the user associated with the mobile user device 150. According to one embodiment of the subject application, the user associated with the mobile device 150 communicates via the computer network 102 with the server 144 so as to receive suitable routing data 804 from the a selected origin to a selected destination, e.g. from an hotel to an airport, conference, or the like. A comparison 806 is then performed between the received location data 802 and the received routing data 804. Distance data generation 808 then occurs corresponding to a distance of each of the alternative business locations based upon the location data 802 from the desired travel route, i.e. routing data 804, in accordance with the output of the comparison 806. Thereafter, display generation 810 occurs corresponding to each of the alternative business locations and the associated distance data.

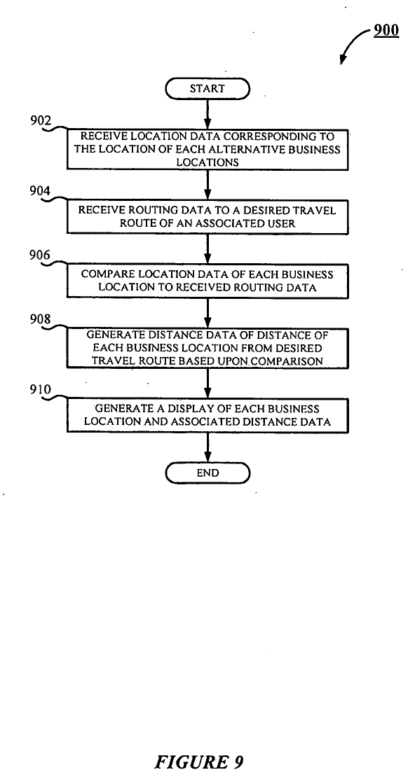

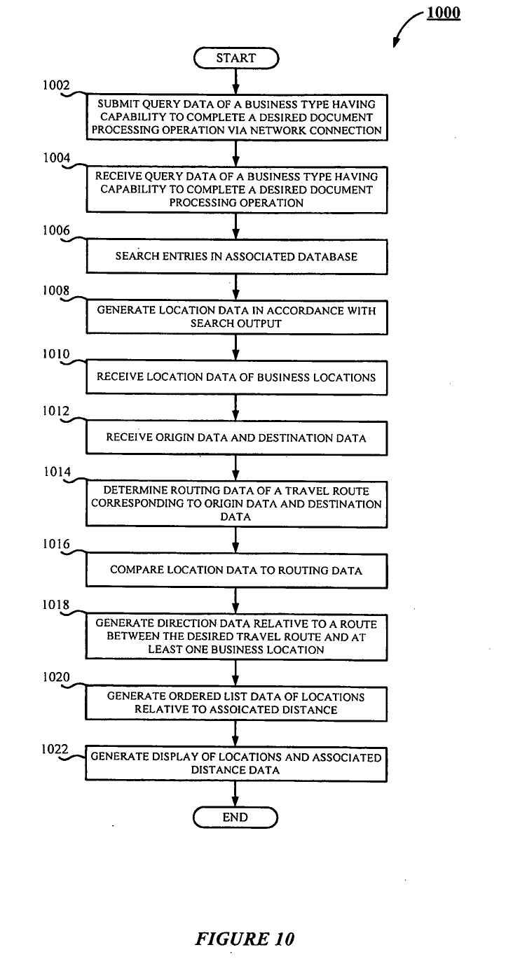

The skilled artisan will appreciate that the subject system 100 and components described above with respect to FIG. 1, FIG. 2, FIG. 3, FIG. 4, FIG. 5, FIG. 6, FIG. 7, and FIG. 8 will be better understood in conjunction with the methodologies described hereinafter with respect to FIG. 9 and FIG. 10. Turning now to FIG. 9, there is shown a flowchart 900 illustrating a route-optimized commercial business locator method in accordance with one embodiment of the subject application. Beginning at step 902, location data is received by the mobile device 150 corresponding to the location of each alternative business location 140 and 142. It will be appreciated by those skilled in the art that the use of the mobile device 150 is for example purposes only, and the subject method is capable of implementation via any suitable computing device known in the art. According to one embodiment of the subject application, the location data is received from the server 144, which is configured to maintain such location data for each business location 140 and 142, or via communications from the business locations 140 and 142 to the mobile device 150, as will be appreciated by those skilled in the art.

At step 904, routing data is received corresponding to a desired travel route of an associated user. Preferably, the routing data corresponds to a travel route from a point of origin and a destination, as selected by the user. In accordance with one embodiment of the subject application, such routing data is received by the mobile device 150 from the server 144, which is capable of being configured with suitable mapping data so as to generate a route between a point of origin and a destination. According to another example embodiment of the subject application, the mobile device 150 accesses a suitable mapping service, e.g. MAPQUEST, GOOGLE, YAHOO, or paid services, so as to receive routing data therefrom.

At step 906, the location data of each of the alternative business locations 140 and 142 is compared to the received routing data. That is, the mobile user device 150 or other suitable device compares the alternative business locations 140 and 142 to the selected routing. Distance data is then generated at step 908 corresponding to a distance of each of the alternative business locations 140 and 142 from the desired travel route in accordance with the comparison performed at step 906. Thereafter, at step 910, a display is generated corresponding to each of the alternative business locations and associated distance data; that is, a display is generated on the mobile device 150 indicating the locations 140 and 142, the travel route, and the calculated distance of the locations 140 and 142 from the travel route.

Referring now to FIG. 10, there is shown a flowchart 1000 illustrating a route-optimized commercial business locator method in accordance with one embodiment of the subject application. The methodology of FIG. 10 begins at step 1002, whereupon a user associated with the mobile device 150 or other suitable computing device submits query data of a business type having a capability to complete a desired document processing operation on an associated electronic document to the server 144 via the computer network 102. In accordance with one embodiment of the subject application, the server 144 maintains a database on the data storage device 146 corresponding to a plurality of alternative business locations 140 and 142, their respective locations, and associated document processing capabilities. The server 144 then receives the query data via the computer network 102 at step 1004. At step 1006, the server 144 performs a search of the entries in the database of the data storage device 146 for those alternative business locations 140 and/or 142 having the desired capabilities.

At step 1008, location data is generated corresponding to a location of each alternative business location 140 and/or 142 resulting from the database search. The location data is then received by the mobile device 150 from the server 144 at step 1010. The mobile device 150 then receives, from the associated user, origin data and destination data corresponding to a starting location and a destination location, e.g. the user's hotel and an airport, convention center, office building, or the like, at step 1012. Routing data is then determined at step 1014 corresponding to a desired travel route, based upon the received origin data and destination data. It will be appreciated by those skilled in the art that such routing data is capable of being generated by an application resident on the mobile device 150, a mapping application resident on the server 144, a mapping application accessed via the computer network 102, e.g. MAPQUEST, GOOGLE, YAHOO, or the like.

The mobile device 150, the server 144, or the like then compares the location data to the routing data at step 1016. At step 1018, the mobile device 150, server 144, or other suitable component associated with the system 100 of FIG. 1 generates direction data relative to a route between the desired travel route and the alternative business locations 140 and/or 142 resulting from the database search; that is, the mobile device 150 or server 144 determines the relative distance of each alternative business location 140 or 142 having the desired capabilities from the desired travel route. An ordered list is then generated at step 1020 corresponding to each business location 140 and 142 relative to their associated distance from the desired travel route. Stated another way, the mobile device 150 or server 144 generates a listing of each alternative business location 140 and 142 having the desired document processing capabilities, based upon their proximity to the desired travel route, e.g. the closest location is listed first, the next closest location is listed second, and the like. Thereafter, at step 1022, a display is generated of the alternative business locations, along with their respective distances from the desired travel route. It will be appreciated by those skilled in the art that such a display is capable of being generated on the mobile device 150, thereby enabling the user to locate a business location 140 or 142 while traveling; on a stationary device (not shown); output via a suitable rendering device; or the like.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications, as are suited to the particular use contemplated. All such modifications and variations are within the scope of the subject application as determined by the appended claims when interpreted in accordance with the breadth to which they are fairly, legally, and equitably entitled.

What is claimed:

1. A route-optimized commercial business locator system, comprising:
a location data input, which location data corresponds to a location of each of a plurality of alternative business locations;
a routing data input, which routing data corresponds to a desired travel route of an associated user;
a comparator operable on location data of each of the plurality of alternative business locations to received routing data;
distance data calculator operable on data corresponding to a distance of each of the plurality of alternative business locations from the desired travel route in accordance with an output of the comparator; and
a display including a depiction of each of the alternative business locations and distance data associated therewith.

2. The system of claim 1, further comprising an ordered list data generator operative to order alternative business locations relative to distance data associated therewith such that the display means includes a display reflective of ordered list data.

3. The system of claim 1, further comprising:
a query data input, which query data corresponds to a query for at least one business type;
a search system responsive to query data and operable on an associated database; and
a location data generator operable on an output of the search means.

4. The system of claim 3, further comprising a network data output port operable to route the query data to the search system.

5. The system of claim 4, further comprising a direction data generator operable on data corresponding to the desired travel route and at least one of the alternative business locations.

6. The system of claim 3, further comprising means adapted for receiving query data corresponding to a business type having a capability to complete at least one selected document processing operation on an associated electronic document.

7. A route-optimized commercial business locator method, comprising the steps of:
receiving location data corresponding to a location of each of a plurality of alternative business locations;
receiving routing data corresponding to a desired travel route of an associated user;
comparing location data of each of the plurality of alternative business locations to received routing data;
generating distance data corresponding to a distance of each of the plurality of alternative business locations from the desired travel route in accordance with an output of the comparison; and
generating a display corresponding to each of the alternative business locations and distance data associated therewith.

8. The method of claim 7, further comprising the step of generating ordered list data corresponding to an ordering of alternative business locations relative to distance data associated therewith such that the display is generated in accordance with ordered list data.

9. The method of claim 7, further comprising the step of:
receiving query data corresponding to a query for at least one business type;
searching entries in an associated database in accordance with received query data; and
generating the location data in accordance with an output of the search.

10. The method of claim 9, further comprising the step of submitting the query data via a data network connection.

11. The method of claim 10, further comprising the step of generating direction data relative to a route between the desired travel route and at least one of the alternative business locations.

12. The method of claim 9, further comprising the step of receiving query data corresponding to a business type having a capability to complete at least one selected document processing operation on an associated electronic document.

13. A route-optimized commercial business locator system, comprising:
means adapted for receiving location data corresponding to a location of each of a plurality of alternative business locations;
means adapted for receiving routing data corresponding to a desired travel route of an associated user;
comparison means adapted for comparing location data of each of the plurality of alternative business locations to received routing data;
means adapted for generating distance data corresponding to a distance of each of the plurality of alternative business locations from the desired travel route in accordance with an output of the comparison means; and
display means adapted for generating a display corresponding to each of the alternative business locations and distance data associated therewith.

14. The system of claim 13, further comprising means adapted for generating ordered list data corresponding to an ordering of alternative business locations relative to distance data associated therewith such that the display means generates the display in accordance with ordered list data.

15. The system of claim 13, further comprising:
means adapted for receiving query data corresponding to a query for at least one business type;
search means adapted for searching entries in an associated database in accordance with received query data; and
means adapted for generating the location data in accordance with an output of the search means.

16. The system of claim 15, further comprising means adapted for submitting the query data to the search means via a data network connection.

17. The system of claim 16, further comprising means adapted for generating direction data relative to a route between the desired travel route and at least one of the alternative business locations.

18. The system of claim 15, further comprising means adapted for receiving query data corresponding to a business type having a capability to complete at least one selected document processing operation on an associated electronic document.
